(19) United States
(12) Patent Application Publication
(10) Pub. No.: US 2017/0238623 A1
(43) Pub. Date: Aug. 24, 2017

(54) Child Safety Seat Compatible Apparel System

(71) Applicants: Jamie Wallace, Gering, NE (US); Rick Wallace, Gering, NE (US)

(72) Inventors: Jamie Wallace, Gering, NE (US); Rick Wallace, Gering, NE (US)

(21) Appl. No.: 15/431,919

(22) Filed: Feb. 14, 2017

Related U.S. Application Data
(60) Provisional application No. 62/297,319, filed on Feb. 19, 2016.

(51) Int. Cl. A41D 11/00; A41D 3/00; A41D 27/00; A41D 1/04

(52) U.S. Cl. CPC A41D 11/00; A41D 1/04; A41D 3/00; A41D 27/00; B60R 22/105

(57) ABSTRACT

An apparel system including a base layer component and a vest component that safely may be worn by a child in a child safety seat with a five-point harness (including convertible, combination, and forward facing with a harness). This may provide warmth for the child while transitioning from indoors to the vehicle and while traveling in the car. This apparel system also may provide protection from the elements should the child be involved in a vehicle accident. The apparel system may include a vest component, such as with a hood, that may be worn over the base layer, such as a jacket, to provide added warmth for outdoor activities. In embodiments, the vest component may not be intended to be worn, and in embodiments should not be worn, while the child is in the child safety seat. This system may be safe, versatile, and convenient.

### RELATED APPLICATIONS

This application is a Non-Provisional application of U.S. Provisional Application Ser. No. 62/297,319 filed on Feb. 16, 2016.

### FIELD OF THE INVENTION

This disclosure describes a jacket/vest system that can be safely worn by a child in a car seat with a five-point harness. The jacket can be worn during travel and the vest can be added for additional warmth during outdoor winter activities.

### BACKGROUND OF THE INVENTION

The safety of a child is the biggest responsibility given to a parent. The safety of a child while riding in a vehicle is so important to society that there are federal and state laws that regulate it. Unfortunately, confusion and inconvenience jeopardize the safety of children while riding in car seats. The present invention Quimby Coat helps eliminate that problem. The Quimby Coat even goes one step further and helps protect the child after a crash has happened.

Parents are advised to keep their children in a five-point harness from birth to approximately 65 pounds (depending on the type of car seat). This can include a wide range of ages. As children grow from an infant to a toddler they move from an infant only car seat (with a carrier and a base) to a convertible seat. This means that the parents must remove the child from the seat instead of keeping the child in the carrier. This is when confusion and inconvenience put the child's life in jeopardy.

Instead of babies being covered in blankets or seat covers, these children are walking and wearing coats to keep them warm. Now the child must move from the warmth of the indoors to the harsh elements outside before being put in their car seat. Well intended parents bundle their kids in the winter coats and “tightly secure” them in their car seats. If the child continues to wear their coat and then the straps cannot be secured tight enough to be safe. If the parent removes the child's heavy coat (which is recommended) then the child is cold during this transition. Once the child is secured in their car seat parents are advised to cover them back up with their coat or a blanket.

In the event of a car accident, most likely, the coat or blanket will fall off. There is a possibility that windows will be broken or significant damage will allow the passengers to be exposed to the elements. Adult occupants in the car can be injured or trapped to a point that they can't help the child. If the child is secured in their car seat and their cover has fallen off then they are exposed to the frigid temperatures, wind, and snow. This could lead to frost bite, hypothermia and death. Response times of rescue units could be considerable. This response time increases in less populated areas, on highways and on interstates. The exposure time increases if extrication is needed. This type of exposure could jeopardize the life of the child regardless of other injuries sustained. The Quimby Coat could be that additional layer of protection that the child needs.

The inconvenience of constantly removing the child's coat before getting into the vehicle and putting it back on when getting out of the vehicle might tempt parents to just let the child wear the coat in the car seat. The fact that kids have to remove their warm coats outside before getting into a (possibly cold) car doesn't appeal to parents either. The fact that their child might be exposed to the elements in the event of a car accident might also tempt parents to leave the coat on the child. Having and promoting the Quimby Coat will also educate and inform parents that heavy winter coats in car seats are dangerous.

The inventors' experiences as a fire fighter, ENT, and captain at a career fire department for 19 years and a certified child safety seat technician for eight years have shown me that this danger exists. Parents want a convenient way to keep their children safe. Parents will find that the Quimby Coat is safe, versatile, and convenient. It also provides enough warmth for their child to play outside. The versatility in transitioning the coat from the base layer which is compatible with a five-point harness to one that is warm enough for winter outdoor play is very simple. A vest is extremely easy for a child to put on, it provides extra warmth because of the layering system over the body and it comes with a hood.

### SUMMARY OF THE INVENTION

The present invention relates to specifically designed child's coat that has the features of providing adequate warmth while at the same time minimizes interference with child car seat harnesses. The investors have named the present invention as the Quimby Coat which will be reference herein. The Quimby Coat is a jacket system that provides the warmth of a winter coat, yet is thin enough to be safely worn in a car seat that has a five-point harness. The body section of the coat is made from a material that provides warmth (fleece, fleece/nylon, Polar Tech Power Shield, etc.), but is thin enough that the straps of the harness fit snugly against the child's body. This feature limits the amount of space between the harness and the body.

This disclosure includes description of an apparel system, such as a base layer (which may be a jacket, coat, or the like)/vest system, that may be safely worn by a child such as in a child safety seat with a five-point harness or the like. The base layer may be worn during travel and the vest may be added for additional warmth, such as during outdoor winter activities.

The body section of this base layer also has a unique cut at the center of the lower half of the jacket. This prevents interference with the buckle part of the harness which ensures a snug fit.

The sleeves of the coat are much like those on a winter coat. They are thicker and heavier than the body portion to provide maximum warmth of a winter coat, but they do not interfere with the harness in the car seat. This is also added protection from the harsh weather in the event of a crash. This makes the coat very versatile. The base layer of the jacket does not come with a hood to prevent the extra bulk between the child and the car seat when the hood is not on the child's head.

The system comes with a removable vest (including a hood) which can be worn when the child is NOT in the car seat. This makes the coat warm enough to be worn outdoors. This layering method in the body section is actually warmer than just a single winter coat layer.

This coat is extremely versatile and convenient. It provides the warmth of a winter coat, but it is safe enough to be worn with a five-point harness. This system uses layering to make it even warmer when worn all together. This jacket also protects the child from the elements in the event of a crash. Currently, the recommended solution is to have the child remove their coat outside, get into the vehicle, secure them in the harness, and cover them back up with their coat. This is uncomfortable for the child, inconvenient for the parent, and unsafe in the event of a crash. If the child is involved in a crash significant damage to the vehicle could leave the child exposed to harsh weather conditions while being secured in their car seat. If they were only covered with a coat or blanket and that covering has fallen off of them, then they can't get to it. It could take several minutes for firefighters to get on scene, and even longer if extrication is needed. These times could be significantly longer in less populated areas or on the interstate and highways.

The convenience of this system will also prevent parents from choosing an unsafe option. It is not easy for parents to have their kids take off their coat outside in blowing snow, get in a potentially cold vehicle, and then cover them with their coat. Then once they reach their destination the child must do the same thing when exiting the vehicle. This is especially difficult with toddlers and multiple children. At times, parents might settle for the unsafe option of allowing their children to ride while wearing their coats. One option a parent might choose would be a 3-in-1 coat. This is not a good option. They do not offer the warmer sleeves or the buckle cut at the bottom. Putting the outer coat of a 3-in-1 over the jacket layer on a toddler is also more difficult than slipping their arms through vest openings on the Quimby Coat. They also don't need to attach the two sleeves inside the coat.

The jacket and vest parts of this system do not attach. This was designed with safety in mind. If both parts zipped together then it might be more convenient for parents to leave the parts connected when the child is getting into the car seat. By not designing the two parts to attach then it is always easy to remove the vest part before the child gets into the car.

### BRIEF DESCRIPTION OF THE DRAWINGS

FIG. 1 is a front perspective drawing showing the front of the base layer whereby the coat is to be worn with the five-point harness.

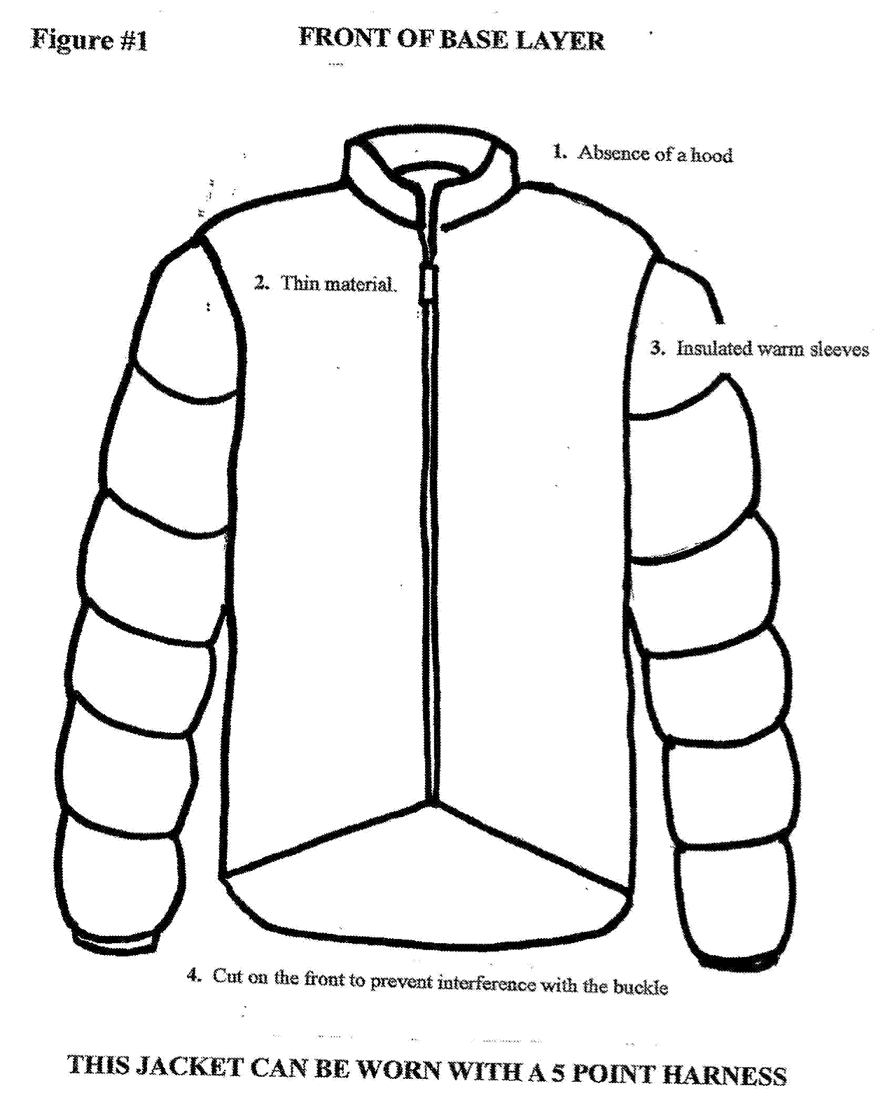

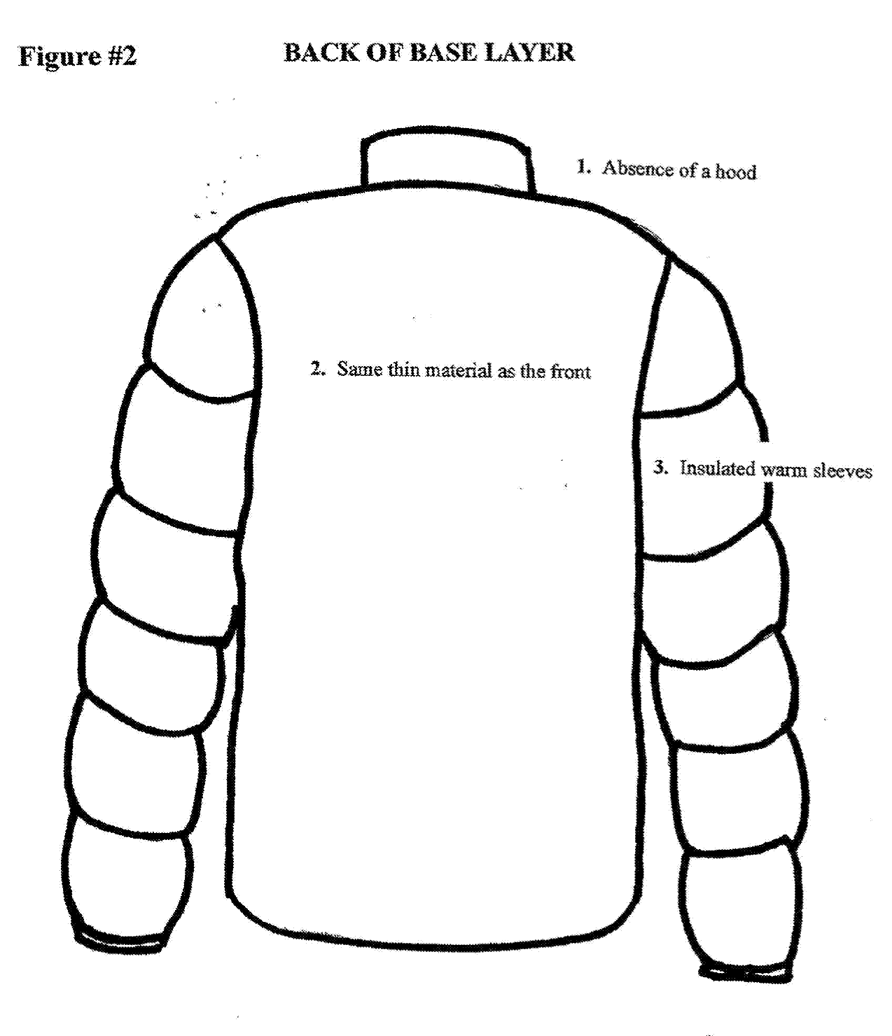

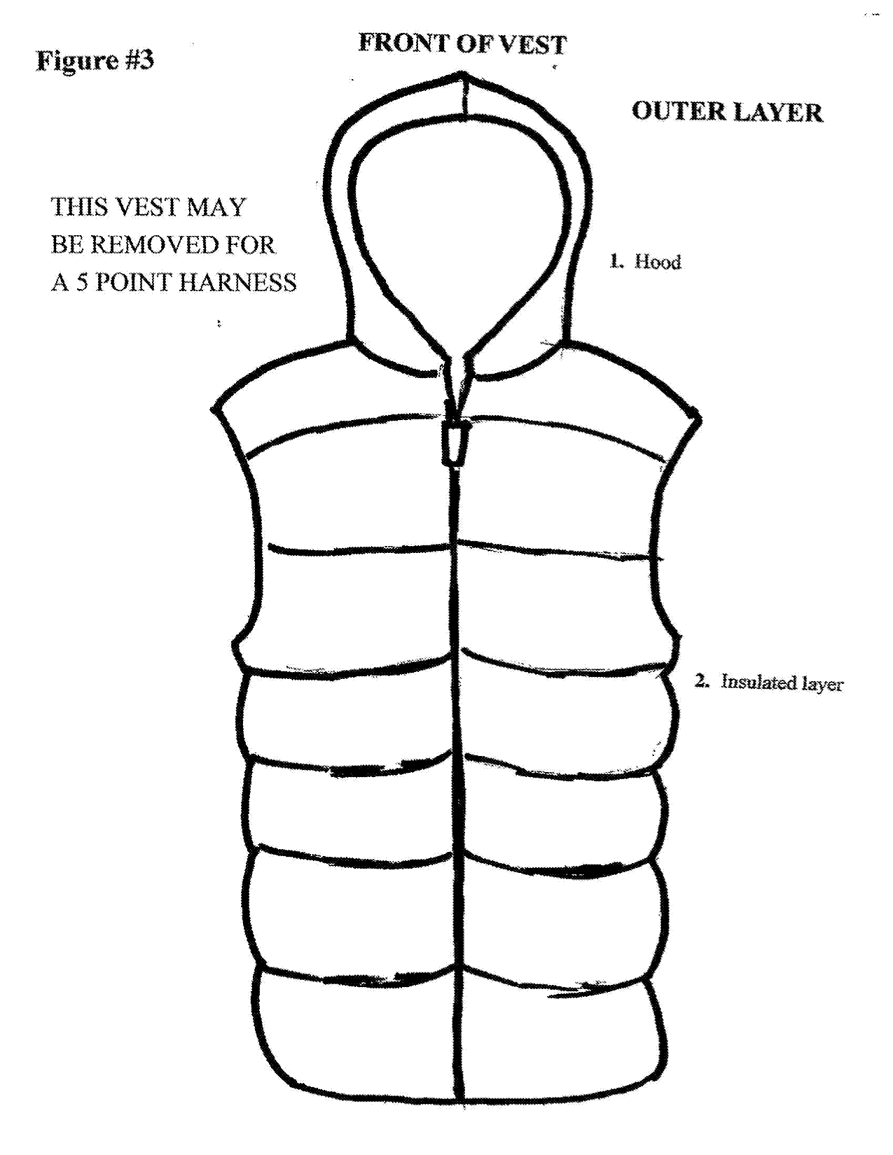

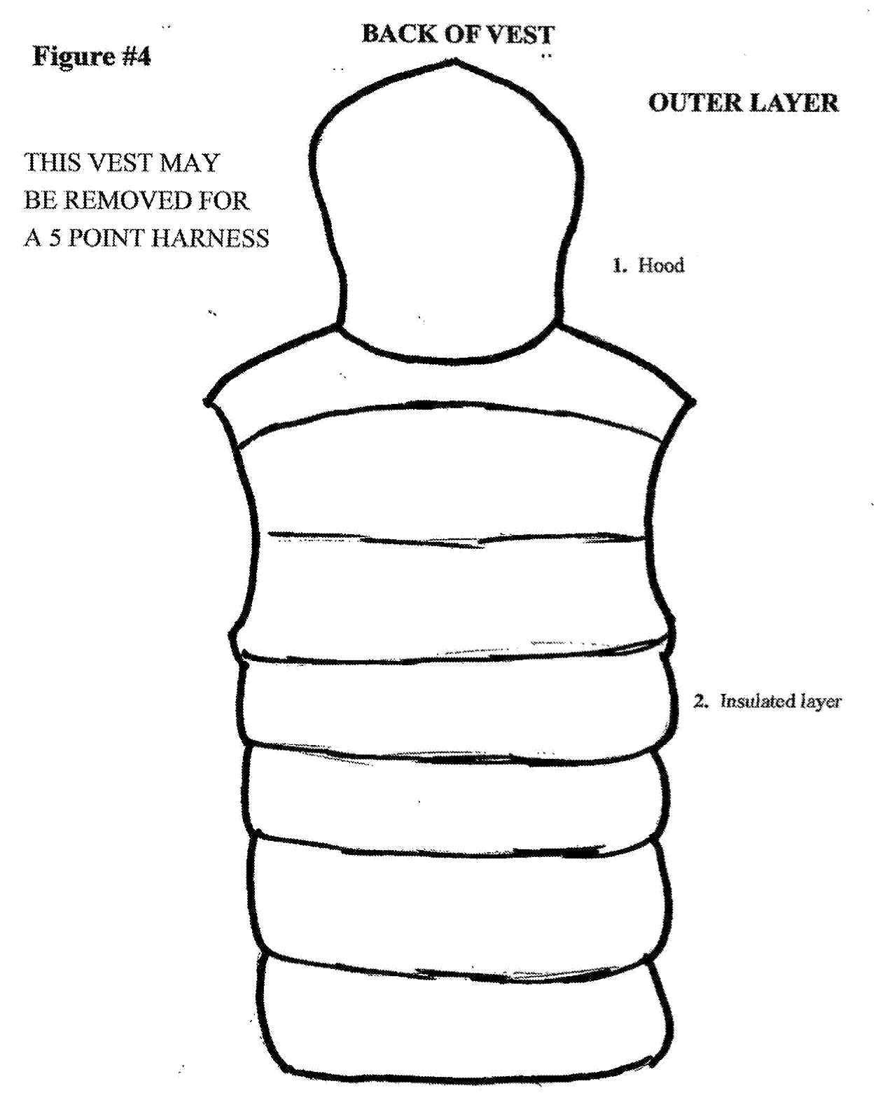

1) The absence of a hood prevents bulk between the child and the back of the car seat.

2) The material that makes up the body portion of the jacket is thin enough to be compatible with the five-point harness, but is durable and warm enough to protect the child against the elements. This part of the jacket also acts as the first layer in a double layer system when worn with the vest to provide extra warmth. This material can be fleece, fleece/nylon, Polar Tech Power Shield, or many similar types of materials. The inventors anticipate that the coat can be fabricated using one or all the listed materials.

3) Insulated sleeves provide the warmth of a winter coat, but do not interfere with the harness.

4) The cut on the bottom half of the front of the coat prevents bulky material from interfering with the buckle. The length of this cut is determined by the measurement of the back of the jacket. A measurement is taken of the back of the jacket from the top of the collar to the bottom of the jacket. The length of the cut on the front is approximately 17% of the back of the jacket. The present application is for all bottom cuts.

FIG. 2 is a rear perspective drawing showing the back of the base layer whereby the coat is to be worn with the five-point harness.

1) The absence of a hood prevents bulk between the child and the back of the car seat.

2) The material that makes up the body portion of the jacket is thin enough to be compatible with the five-point harness, but is durable and warm enough to protect the child against the elements. This part of the jacket also acts as the first layer in a double layer system when worn with the vest to provide extra warmth. This material can be fleece, fleece/nylon, Polar Tech Power Shield, or many similar types of materials. The inventors anticipate that the coat can be fabricated using one or all the listed materials.

3) Insulated sleeves provide the warmth of a winter coat, but do not interfere with the harness.

4) The cut on the bottom half of the front of the coat prevents bulky material from interfering with the buckle. The length of this cut is determined by the measurement of the back of the jacket. A measurement is taken of the back of the jacket from the top of the collar to the bottom of the jacket. The length of the cut on the front is approximately 17% of the back of the jacket. The present application is for all bottom cuts.

FIG. 3 is a view of the front of a vest layer in one exemplary embodiment. In some embodiments, this part of the apparel system may not be intended to be worn, and in some embodiments should not be worn, while the child is in a five point harness or similar safety device. Additional points to note may include:

1. The hood may provide warmth.

2. The body portion may be insulated and may work with the base layer to provide extra warmth while the child is out of the child safety seat. This part of the apparel system may not be intended to be worn, as in some embodiments, should not be worn, while the child is in a five-point harness or similar safety seat.

FIG. 4 is a view of the back of a vest layer in one exemplary embodiment. In some embodiments, this part of the apparel system may not be intended to be worn, as in some embodiments, should not be worn, while the child is in a five-point harness or similar safety seat. Additional points to note may include:

1. The hood may provide warmth.

2. The body portion may be insulated and may work with the base layer to provide extra warmth while the child is out of the child safety seat. This part of the apparel system may not be intended to be worn, as in some embodiments, should not be worn, while the child is in a five-point harness or similar safety seat.

### DESCRIPTION OF THE PREFERRED EMBODIMENTS

The present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

An apparel system may provide warmth, such as of a winter coat, yet may be thin enough to be safely worn in a child safety seat, such as one that has a five-point harness. The base layer may be a jacket, coat, or the like that may be made from a material that provides warmth (such as fleece, fleece/nylon, Polartec® Power Shield®, or the like), but may be thin enough that straps, such as of a harness, may fit snugly against the child's body. This feature may limit the amount of space between the harness and the body.

The base layer also may have a novel cut, such as at the center of the lower half of a jacket or the like, that may prevent interference with a fastener, such as the buckle part of a harness or the like. This may contribute to ensuring a snug fit.

The base layer may have a body section and one or more sleeve sections. The sleeves of the base layer may be thicker and heavier than the body section, such as to provide warmth, for example in the nature of a winter coat, but they may not interfere with straps, such as the harness in a child safety seat. This also may add protection, such as from harsh weather, in the event of a crash. This may make the apparel system very versatile. The base layer also may not come with a hood, such as to prevent the extra bulk between the child and the child safety seat when the hood is not on the child's head.

The apparel system may come with a removable vest (which may include a hood) which may be worn when the child is not in the child safety seat. This may make the apparel system, as perhaps comprising the base layer and vest together, warm enough to be worn outdoors. This layering method may be warmer than just a single winter coat layer.

The apparel system may be extremely versatile and convenient. It may provide the warmth of a winter coat, but may be safe enough to be worn in a child safety seat, such as with a five-point harness. The apparel system may use layering to make it even warmer when worn all together. The apparel system also may protect the child from the elements in the event of a crash.

Currently, a typically recommended solution may be to have the child remove their coat outside, get into a vehicle, be secured into a harness, and be covered back up with their coat. This may be uncomfortable for the child, inconvenient for the parent, and unsafe in the event of a crash. If the child is involved in a crash, significant damage to the vehicle may leave the child exposed to harsh weather conditions while being secured in their child safety seat. If the child were only covered with a coat or blanket, and that covering were to have fallen off, then the child may not be able to get to it. It may take several minutes for emergency responders to get on scene, and perhaps even longer if extrication is needed. These times may be significantly longer in less populated areas or on the interstate and highways.

The convenience of the apparel system also may prevent parents from choosing an unsafe option. It may not be easy for parents to have their children take off their coat outside in blowing snow, get in a potentially cold vehicle, and then cover them with their coat. Then once they reach their destination, the child may have to do the same thing when exiting the vehicle. This may be especially difficult with toddlers and multiple children. At times, parents might settle for the unsafe option of allowing their children to ride while wearing their coats. One option a parent might choose could be a 3-in-1 coat. This may not be a good option. Such coats may not offer the warmer sleeves or the novel cut as described herein. Putting the outer coat of a 3-in-1 over the jacket layer on a toddler also may be more difficult than slipping their arms through vest openings on the apparel system described herein. It also may not be required to attach the two sleeves inside the coat.

In some embodiments, the base layer (perhaps in the form a jacket, coat, or the like) and vest components of the apparel system may not attach. This may provide a safety benefit. If both parts attached together (such as by zipping or the like), then it might be more convenient for parents to leave the parts connected when the child is getting into a child safety seat. By not permitting the two parts to attach, it may be always easy to remove the vest component before the child gets into the car.

The following clauses may be relevant in claiming or otherwise describing the inventive technology:

1) The garment may be safe for children to wear while secured in a child safety seat with a five-point harness.

2) The garment also may provide the warmth of a winter coat and may be worn during outdoor winter activities.

3) The garment may have a base layer having a body section made of thinner material that may be compatible with a five-point harness.

4) The absence of a hood on the base layer may eliminate bulk between the child and the back of the child safety seat.

5) A novel cut on the lower half of the body section of the base layer may prevent interference with the buckle of a harness.

6) Heavy winter coat-type sleeves may provide extra warmth without interfering with the tightness of a harness.

7) The vest component may provide warmth and may allow the apparel system to function as a winter coat that may be worn in cold weather conditions.

8) The warmth of the basic layer may make a child warmer than the covering method (for example, when a child may be secured in a child safety seat in a shirt or light jacket and their winter coat or a blanket is used to cover them) in the event of a crash. It may protect the child from the elements.

9) The apparel system may make it more convenient for parents so that it may be easier to make a correct and safe choice for securing their children into a child safety seat.

As can be easily understood from the foregoing, the basic concepts of the present inventive technology may be embodied in a variety of ways. It involves both appareling techniques as well as devices to accomplish the appropriate apparel. In this application, the appareling techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of “apparel” should be understood to encompass disclosure of the act of “appareling”—whether explicitly discussed or not—and, conversely, were there effectively disclosure of the act of “appareling”, such a disclosure should be understood to encompass disclosure of “apparel” and even a “means for appareling.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the apparel devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A garment designed to provide warmth and safety for a child to wear while secured in a car seat with a five-point harness, and whereby said garment also provides the warmth of a winter coat and can be worn during outdoor winter activities, comprising;
a body section having one or more portions that are made of thinner material that is compatible with a five-point harness; and
whereby the other portions of the body section have thicker material that is compatible with a five-point harness.

2. The garment of claim 1, further comprised that there is an absence of a hood on the base layer which eliminates bulk between the child and the back of the car seat.

3. The garment of claim 1, whereby a unique cut design on the lower half of the body section on the base layer prevents interference with the buckle of the harness.

4. The garment of claim 1, whereby a heavy winter coat type sleeves provide extra warmth, but do not interfere with the tightness of the harness.

5. The garment of claim 1, whereby the vest section provides warmth and allows the coat to adapt to a winter coat that can be worn in cold weather conditions.

6. The garment of claim 1, whereby the design of the warm basic layer jacket also makes the child warmer than the covering method in the event of a crash and protects the child from the elements.

7. The garment of claim 1, whereby the entire design of this system makes it more convenient for parents so it is easier to make the correct and safe choice.

8. The garment of claim 1, whereby the base layer may be a jacket, coat, or the like that may be made from a material that provides warmth fabricated for the list of fleece, fleece/nylon, Polartec® Power Shield®, or the like, and any combinations thereof.

9. The garment of claim 1, whereby certain portions of the garment are fabricated and designed thin enough that straps, such as of a harness, may fit snugly against the child's body.

10. The garment of claim 1, whereby the thin section of the garment limit the amount of space between the harness and the body.

11. A garment designed to provide warmth and safety for a child to wear while secured in a child car seat with a five-point harness, whereby said garment system also provides the warmth of a winter coat and can be worn during outdoor winter activities, comprising;
a body section having one or more portions that are made of thinner material that is compatible with a five-point harness;
where other portions of the body section have thicker material that is compatible with a five-point harness, and
whereby the garment lacks any hood element on the base layer which eliminates bulk between a child and a back of a children's car seat.

12. The garment of claim 11, whereby a unique cut design on the lower half of the body section on the base layer prevents interference with the buckle of the harness.

13. The garment of claim 11, whereby a heavy winter coat type sleeves provide extra warmth, but do not interfere with the tightness of the harness.

14. The garment of claim 11, whereby the vest section provides warmth and allows the coat to adapt to a winter coat that can be worn in cold weather conditions.

15. The garment of claim 11, whereby the design of the warm basic layer jacket also makes the child warmer than the covering method in the event of a crash and protects the child from the elements.

16. The garment of claim 11, whereby the entire design of this system makes it more convenient for parents so it is easier to make the correct and safe choice.

17. The garment of claim 11, whereby the base layer may be a jacket, coat, or the like that may be made from a material that provides warmth fabricated for the list of fleece, fleece/nylon, Polartec® Power Shield®, or the like, and any combinations thereof.

18. The garment of claim 11, whereby certain portions of the garment are fabricated and designed thin enough that straps, such as of a harness, may fit snugly against the child's body.

19. The garment of claim 11, whereby the thin section of the garment limit the amount of space between the harness and the body.
